(19) United States
(12) Patent Application Publication
(10) Pub. No.: US 2022/0309509 A1
(43) Pub. Date: Sep. 29, 2022

(54) A SECURE PAYMENT SYSTEM WITH EMV CARD TRANSACTION FLOW AND PIN CONFIRMATION WITHOUT SHARING CARD INFORMATION OF THE MOBILE PHONE, COMPUTER OR TABLET OF THE CARDHOLDER AND A METHOD THEREOF

(71) Applicant: KARTEK KART VE BILISIM TEKNOLOJILERI TICARET ANONIM SIRKETI, Istanbul (TR)

(72) Inventors: Ahmet AKGÜN, Istanbul (TR); Ibrahim DURAK, Istanbul (TR)

(21) Appl. No.: 17/286,978

(22) PCT Filed: Oct. 12, 2020
(86) PCT No.: PCT/TR2020/050937

§ 371 Date: Apr. 20, 2021

(30) Foreign Application Priority Data
Mar. 12, 2020 (TR) 2020/03814

(51) Int. Cl. G06Q 20/40; G06Q 20/32; G06Q 20/34

(52) U.S. Cl. CPC G06Q 20/4012; G06Q 20/326; G06Q 20/352

(57) ABSTRACT

Disclosed is a system which enables a consumer to make payment during e-commerce or m-commerce transactions, by entering a PIN when EMV contactless and a verification is required for the card holder, by scanning (tap) the card to a mobile application without sharing card information and a method thereof.

### TECHNICAL FIELD

The invention relates to a system which enables the consumer to make payment during e-commerce or m-commerce transactions, by entering PIN when EMV contactless and a verification is required for the card holder, by means of scanning (tap) the card to a mobile application without sharing card information and a method thereof.

### PRIOR ART

Today, e-commerce or m-commerce transactions are realized by means of different payments options such as credit card, shopping credit, money order, EFT, wallet applications. While it is possible to re-enter our card information during payments realized by credit cards, it is also possible to use the credit card information in the next shopping by storing the same by means of wallet applications without requiring re-entering the same. Although many precautions are taken for e-commerce and m-commerce transactions so as to provide safety, a population that does not consider it as safe, does not want to share credit card information. Although, high turnovers and increase in the number of users are experienced in the online shopping in recent years, safety is still concerned. Hence, today subjects such as stolen card information, overdrawing from the card etc. are still concerned. Therefore solutions in which the card information is not shared in anyway in online payments and which provides to make payment with PIN when EMV contactless and cardholder verification is required in the payment flow so as to eliminate the online shopping safety concern in the present art, are required.

As a result, the abovementioned problems and the problems that cannot be solved in the light of the present art have made it necessary to make an improvement in the relevant technical field.

### BRIEF DESCRIPTION OF THE INVENTION

The present invention relates to a secure payment system with EMV card transaction flow and PIN confirmation without sharing card information of the mobile phone, computer or tablet of the cardholder and a method thereof so as to eliminate the abovementioned disadvantages and bring novel advantages to the relevant technical field.

The main aim of the invention is to provide a system and a method which does not share card information in anyway in online payments and provides to realize payment with PIN when EMW contactless and cardholder verification is required in the payment flow.

Another aim of the invention is to provide a system and a method which allows the final user an experience of completing the payment through a physical POS device in online shopping.

Another aim of the invention is to develop a system and a method which provides the safe environment enabled by the closed circuit network in the physical POS devices by using whitebox cryptography.

Another aim of the invention is to provide a system and a method which separates the input data received externally to the mobile device, keys used for storing, processing and encoding the input data, relevant application or layers and whitebox layers.

In order to fulfill all aims mentioned above and obtained from the following detailed description, the present invention is a system which does not share payment instrument information such as credit card, bank card etc. in any way in online payments made in the virtual stores and provides to realize payment with PIN when EMW contactless and cardholder verification is required in the payment flow. Accordingly, the system comprises the following;
mobile device having near field communication capability,
POS application which runs on said mobile device and enables contactless payments by means of approximating the payment instrument (such as credit card, wearable device etc.) to the mobile device,
PIN application which runs on said mobile device, provides a user interface for safe PIN entry and transmits the received PIN information to the POS application in a safe manner,
L2 kernel where the kernel application of the payment schemes are running,
L3 service layer which manages the user interface of the POS application, experience and workflows,
Whitebox memory which provides operation of POS application and safety for PIN application, key generation and cryptographic algorithms with software,
Server that manages the POS application.

At the same time, our invention covers the method which does not share payment information such as credit card, bank card etc. in any way in online payments made in the virtual stores and provides to realize payment with PIN when EMV contactless and cardholder verification is required in the payment flow. Accordingly, the method comprises the following process steps;
the consumer's passing to the payment step by creating a shopping basket from the virtual store,
the consumer's selecting the POS application option that provides payment at the payment step,
in case shopping is performed over a web site;
   When payment option is selected by means of POS application, creating a QR code that comprises the transaction information and merchant information,
   the user's reading QR code by means of opening the POS application running on the mobile device,
in case transaction is carried out over the mobile application of the merchant;
   When payment option is selected by means of POS application, activating the POS application by means of triggering the same,
displaying the transaction information on the POS application and initiating the payment flow by tapping the payment instrument to the mobile device,
controlling the payment amount whether it is above the cardholder verification limit or not,
In case the transaction amount is above the cardholder verification limit, L2 kernel where the core applications of the payment schemes are running, notifying the L3 service layer that manages the user interface of the POS application, experience and work flows and triggering the initiation of PIN application that provides the user interface for PIN entry,
Waiting for the PIN entry by displaying the numerical keypad where the numbers are located on the PIN application display randomly,
when the user presses any number on the keypad that is displayed on the PIN application, PIN application progresses as follows;
   changing the location of the numbers randomly,
   Placing the entered number to the rightmost by decoding PIN array with PEK and again deleting the PIN array from the whitebox memory after it is encoded by PEK,
   continuing the transaction until the user presses “Enter” button,
   PIN application's preparing the PIN login message
      in case the user presses the “Enter” button, display result being successful and comprising PIN array encoded with PEK, encoding the complete message by means of RSA open key in Whitebox form, transmitting the same to the POS application over TCP/IP socket,
   in case the user presses the “Cancel” button, displaying failed result on the screen
POS application's decoding the authorization request message with RSA special key in Whitebox form, including the PIN data within the authorization message,
POS application's transmitting the authorization request message to the server that manages the POS application,
the server's transmitting the authorization request to the bank having POS application (acquirer) after converting the same into ISO request format,
Transmitting the authorization message transmitted to the bank (acquirer) having the POS application to the bank (issuer) issuing the payment instrument,
the bank's (issuer) receiving the authorization request message, separating ISO fields and deciding the authorization approval and rejection decision,
in case the authorization is not approved based on any reason, the flow proceeds as follows;
   the issuer bank transmitting the rejection method to the acquirer bank,
   The acquirer bank transmitting the rejection message to the server,
   the server's transmitting the rejection message to the POS application and the virtual store,
   Displaying the “transaction is rejected” message on the interface of the POS application,
in case the authorization process is successful, the flow proceeds as follows;
   the issuer bank transmitting the approval message to the acquire bank,
   Transmitting the approval message to the server by the acquirer bank,
   the server's transmitting the approval message to the POS application and virtual merchant,
   Displaying the “transaction is approved” message on the interface of the POS application.

In order to understand the advantages of the present invention with its structure and additional elements, it shall be evaluated with the following defined figures.

### BRIEF DESCRIPTION OF DRAWINGS

FIG. 1 is the general view of the inventive system.

FIG. 2 is the flow chart of the inventive method.

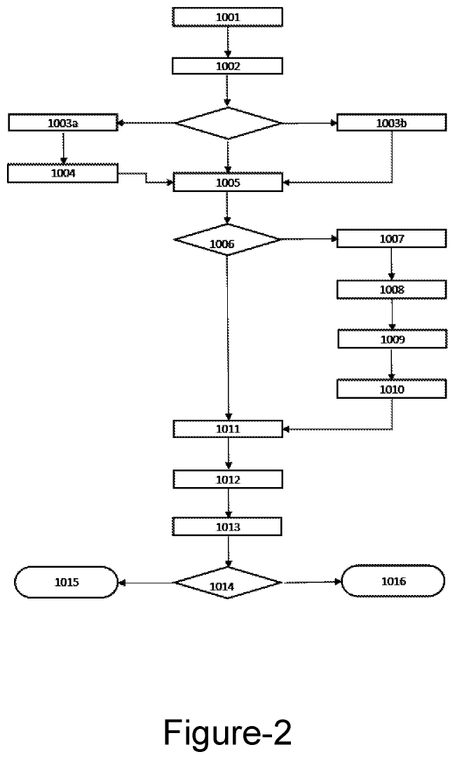

### REFERENCE NUMBERS

1. Payment instrument
2. Mobile device
   2.1. POS application
   2.2 PIN application
   2.3 L2 kernel
   2.4 L3 service layer
   2.5 Whitebox memory
3. Server
4. The bank issuing the payment instrument (issuer)
5. The bank having POS application (acquirer)
6. Virtual store

### DETAILED DESCRIPTION OF THE INVENTION

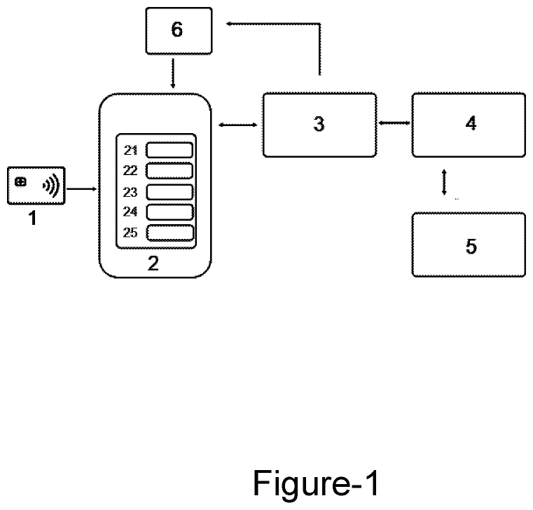

In this detailed description, the inventive novelty is described by means of examples only for clarifying the subject matter such that no limiting effect is created. Our invention is a system which does not share payment instrument (1) information such as PAN, expiry date and CVV of credit card, bank card etc. in any way in online payments made in the virtual stores (6) and provides to realize payment with PIN when EMV contactless and verification of the payment instrument (1) owner is required in the payment flow. FIG. 1 is the schematic view of the inventive system. Accordingly, the system comprises the following; mobile device (2) having near field communication capability, POS application (2.1) which runs on said mobile device (2) and enables contactless payments by means of approximating the payment instrument (1) to the mobile device (2), PIN application (2.2) which runs on said mobile device (2), provides a user interface for safe PIN entry and transmits the received PIN information to the POS application in a safe manner, L2 kernel (2.3) where the kernel application of the payment schemes are running, L3 service layer (2.4) which manages the user interface of the POS application (2.1), experience and work flows, Whitebox memory (2.5) which provides operation of POS application (2.1) and safety for PIN application (2.2), key generation and cryptographic algorithms with software, server (3) that manages the POS application (2.1).

In the inventive system, the consumer creates the shopping basket over the virtual store (6) and proceeds to the payment step. Payment option is selected by means of POS application (2.1) in the payment step. Different from the conventional e-commerce and m-commerce shopping, card information is definitely not shared. When the consumer selects the payment option by means of the POS application (2.1), if he/she makes transaction over the mobile application of the merchant, when the payment option is selected by the POS application (2.1), the POS application (2.1) is activated by means of triggering the same. If the user makes shopping over a web site, he/she opens the POS application (2.1) on the mobile device (2) and scans the QR code displayed on the payment screen. Information about the transaction and merchant is received by means of QR code. The amount of the transaction is seen on the POS application (2.1) and the user is required to tap the payment instrument (1) (credit card etc.) to the mobile device (2). The consumer taps the payment instrument (1) to the mobile device (2). The transaction amount is controlled whether it is higher than the cardholder verification limit. If the transaction amount is higher than the cardholder verification limit, L2 kernel (2.3) informs the L3 service layer (2.4) and initiation of PIN application (2.2) is triggered. When the user presses any number on the keypad that is displayed on the PIN application (2.2), PIN application (2.2) progresses as follows; the location of the numbers is modified randomly. The entered number is located to the rightmost by decoding PIN array with PEK and again PIN array is deleted from the whitebox memory (2.5) after it is encoded by PEK. The transaction continues until the user presses “Enter” button. PIN application (2.2) prepares PIN login message. When the user presses the “Enter” button, the display result is successful and comprises PIN array encoded with PEK. The entire message is encoded by the RSA key in Whitebox form and is transmitted to the POS application (2.1) over TCP/IP socket. If the user presses “Cancel” button, then a failed result is shown on the display. POS application (2.1) decodes the authorization request message with RSA special key in Whitebox form, includes PIN data and transmits the same to the server (3). If the transaction amount is less than the cardholder verification limit, PIN application (2.2) is not activated. POS application (2.1) sends authorization request message to the server (3). The received authorization request message is transmitted to the acquirer bank (5). The acquirer bank (5) transmits this message to the bank (Issuer) (4)) for the authorization approval. The issuer bank (4) realizes the authorization controls and transmits the approval or rejection message to the acquirer bank (5). The acquirer bank (5) sends the approval or rejection message to the server (3). The server (3) transmits the result both to the POS application (2.1) and to the virtual store (6) as “transaction is approved” or “transaction is rejected”.

1. A system which does not share payment instrument information such as credit card, bank card etc. in any way in online payments made in virtual stores and provides to realize payment with PIN when EMV contactless and cardholder verification is required in the payment flow, characterized by comprising:
a mobile device having near field communication capability;
a POS application which runs on said mobile device and enables contactless payments by means of approximating the payment instrument to the mobile device;
a PIN application which runs on said mobile device, provides a user interface for safe PIN entry and transmits the received PIN information to the POS application in a safe manner;
L2 kernel where the kernel application of the payment schemes are running;
L3 service layer which manages the user interface of the POS application, experience and workflows;
a Whitebox memory which provides operation of POS application and safety for PIN application, key generation and cryptographic algorithms with software; and
a server that manages the POS application.

2. A method which does not share payment instrument information such as credit card, bank card etc. in any way in online payments made in virtual stores and provides to realize payment with PIN when EMV contactless and cardholder verification is required in the payment flow, characterized by comprising of the following steps;
a consumer's passing to the payment step by creating a shopping basket from the virtual store;
the consumer's selecting the POS application option that provides payment at the payment step;
in case shopping is performed over a web site;
payment option is selected by means of POS application, creating a QR code that comprises the transaction information and merchant;
the user's reading QR code by means of opening the POS application running on the mobile device;
in case transaction is carried out over the mobile application of the merchant;
when payment option is selected by means of POS application, activating the POS application by means of triggering the same;
displaying the transaction information on the POS application and initiating the payment flow by tapping the payment instrument to the mobile device;
controlling the transaction amount whether it is above the cardholder verification limit or not;
in case the transaction amount is above the cardholder verification limit, L2 kernel where the core applications of the payment schemes are running, notifying the L3 service layer that manages the user interface of the POS application, experience and work flows and triggering the initiation of PIN application that provides the user interface for PIN entry;
waiting for the PIN entry by displaying the numerical keypad where the numbers are located on the PIN application display randomly;
when the user presses any number on the keypad that is displayed on the PIN application, PIN application progresses as follows:
changing the location of the numbers randomly;
placing the entered number to the rightmost by decoding PIN array with PEK and again deleting the PIN array from the whitebox memory after it is encoded by PEK;
continuing the transaction until the user presses “Enter” button;
PIN application preparing PIN entry message:
in case the user presses the “Enter” button, display result being successful and comprising PIN array encoded with PEK, encoding the complete message by means of RSA open key in Whitebox form, transmitting the same to the POS application over TCP/IP socket;
in case the user presses the “Cancel” button, displaying failed result on the screen
POS application's decoding the authorization request message with RSA special key in Whitebox form, including the PIN data within the authorization message;
POS application's transmitting the authorization request message to the server that manages the POS application;
the server's transmitting the authorization request to the bank (acquirer) after converting the same into ISO request format (1012),
transmitting the authorization message transmitted to the bank (acquirer) to the bank (issuer);
the bank (issuer) receiving the authorization request message, separating ISO fields and deciding the authorization approval and rejection decision;
in case the authorization is not approved based on any reason, the flow proceeds as follows:
the issuer bank transmitting the approval or rejection message to the acquirer bank;
the acquirer bank transmitting the rejection message to the server;
the server's transmitting the rejection message to the POS application and the virtual store;
displaying the “transaction is rejected” message on the interface of the POS application;
in case the authorization process is successful, the flow proceeds as follows:
the issuer bank's transmitting the approval message to the acquirer bank;
the acquirer bank's transmitting the approval message to the server;
the server's transmitting the approval message to the POS application and the virtual store;
displaying the “transaction is approved” message on the interface of the POS application.
